(19) United States
(12) Patent Application Publication
(10) Pub. No.: US 2007/0196408 A1
(43) Pub. Date: Aug. 23, 2007

(54) Nontoxic starch-based contact pesticide and method of using the same

(76) Inventor: Jack Carson, Lafayette, LA (US)

Correspondence Address: RADER FISHMAN & GRAUER PLLC, LION BUILDING, 1233 20TH STREET N.W., SUITE 501, WASHINGTON, DC, 20036, US

(21) Appl. No.: 11/704,973

(22) Filed: Feb. 12, 2007

Related U.S. Application Data
(60) Provisional application No. 60/771,898, filed on Feb. 10, 2006.

(51) Int. Cl. A01N 43/04

(52) U.S. Cl. 424/405; 514/60

(57) ABSTRACT

A nontoxic starch-based contact pesticide solution which is nontoxic to humans, pets, birds, vegetation, and other non-targeted organisms, which is safe for use in agricultural applications, and which can be used without risk of harmful effects on soil systems, ground water systems , air quality, or any portion of the environment where the pesticide is applied. The pesticide solution is comprised of an aqueous starch-based composition which adheres to the targeted pest, killing the targeted pest. The aqueous composition is composed of water in which one or more carbohydrate compounds are dissolved, including starch compounds. The pesticide is effective in eliminating a variety of flying and crawling pests, such as insects and arachnids, and is useful in combating soil based ant colonies residing in beds or mounds.

### CROSS REFERENCE TO RELATED APPLICATIONS

This application claims the benefit under 35 U.S.C. § 119 of previously filed provisional patent application Ser. No. 60/771,898, filed on Feb. 10, 2006 and entitled “Nontoxic pesticide and method of using the same,” the entire contents of which is hereby incorporated by reference.

### BACKGROUND OF THE INVENTION

1. Field of Technology

The present invention relates to a contact pesticide. More particularly, the present invention relates to a nontoxic contact pesticide composition which kills pests such as crawling and flying insects without compromising the safety of the area and surroundings where the composition is applied, and which can be safely used in agricultural pesticide applications.

2. Description of the Related Art

The agricultural industry utilizes significant time and money resources in removing insects and other pests from land and crops in order to maintain a high quality and quantity of food products. Additionally, individual and public landowners spend hundreds of dollars or more every year battling infestation from flying and crawling insects. Time and resources must be utilized in removing insects and other pests from schools, businesses, and other outdoor and indoor venues where the public works and gathers, making the places both safe and aesthetically pleasing. In recent years, landowners throughout the Southern United States have also had to deal with the increasing nuisance of fire ants, which are particularly difficult to eliminate due to the lack of natural predators.

Pesticides that have been determined to be effective also tend to be poisonous and dangerous to a variety of plants and wildlife. The compositions not only kill or harm pests, but also have the potential to seriously harm humans, pets, birds, fish and other animals that come in contact with the chemicals. Consequently, the most effective, and thus toxic, formulations cannot be applied to battle pests in day care centers, schools, colleges, parks, commercial properties, and so forth. The government has taken notice of the harmful effects of the poisons in pesticides, and has seriously restricted or banned many toxic compositions from sale or use.

In recent years, the use of common chemical pesticides has led to severe and widespread resistance in many key agricultural pests, severely reducing the overall effectiveness of the insecticides. In response, farmers have been forced to apply larger and larger quantities of insecticide to combat the pests. Many common toxic pesticides tend to remain in the soil and water systems for many years after application. The increased use of toxic pesticides presents a number of concerns, including the effects of the chemicals on non-targeted species, increased agricultural costs, and concerns for consumer safety.

### SUMMARY OF THE INVENTION

It is an object of the present invention to provide a contact pesticide solution that includes compounds which are nontoxic to humans, pets, birds, vegetation, and other non-targeted organisms, and additionally to provide a pesticide that can be used without harmful effects on the soil systems, ground water systems, air quality, or any portion of the environment where the pesticide is applied.

It is also an object of the present invention to provide a contact pesticide, which includes an aqueous carbohydrate solution which adheres to and coats an exterior portion of a targeted pest, resulting in the death of the targeted pest.

It is also an object of the present invention to provide a pesticide solution which can easily adhere to the target pests, but which can also be easily dissipated and washed away from the targeted area using water.

It is a further object of the present invention to provide a method of combating pests, which includes the steps of contacting a pest with an aqueous carbohydrate solution which adheres to and coats an exterior portion of the pest.

The present invention is a non-toxic carbohydrate based solution which acts as a contact pesticide. The solution is an aqueous composition which coats an exterior portion of a targeted pest, killing the targeted pest by means of the coating, and a method of using the pesticide in combating pests. The aqueous composition is composed of water in which one or more carbohydrate compounds are dissolved. The carbohydrates present in the aqueous solution are preferably polysaccharide compounds, and are more preferably starch compounds. The pesticide is effective against a variety of flying and crawling pests, such as insects and arachnids. The pesticide is particularly effective in combating ant populations and flying insects such as bees, wasps, and wood termites although a wide variety of additional targeted insects and other pests are envisioned in the scope of this invention.

Additional objects, advantages and novel features of the invention will be set forth in the description which follows or may be learned by those skilled in the art through reading these materials or practicing the invention. The objects and advantages of the invention may be achieved through the means recited in the attached claims.

### DETAILED DESCRIPTION OF THE INVENTION

The present invention is an aqueous composition which acts as a contact pesticide, killing a targeted pest by coating an exterior portion of the pest, and a method of utilizing the contact pesticide in combating pests. The pesticide solution partially or completely coats a targeted pest, killing the pest by means of the coating contacting the pest. The pesticide solution may be poured or sprayed directly onto the pests. Alternatively, the pesticide solution may be applied to an infested region of soil or other concealed region, for example, by pouring onto the region. With respect to soil dwelling pests, the water in the solution acts as a delivery agent, allowing the composition as a whole to penetrate the region of soil in which the pests are residing. Because water first tends to flow through strata of minimal density before occupying other layers of soil, the solution tends to follow the tunnels and loose dirt created by the pests.

The aqueous pesticide includes one or more carbohydrate compounds dissolved therein. The carbohydrate compounds present in the solution are nontoxic and biodegradable. Therefore, in addition to eliminating detrimental effects to the immediate environment, the formulation is not hazardous if it comes into contact with the ground water table, and is not a danger to consumers of a plant crop which has been treated with the pesticide. Because of these advantages, the present invention can be used not only on private land, but in public parks, schools, and other areas where toxic pesticides may not be legally applied to the ground to combat pests. Additionally, the pesticides can be safely used on agricultural crops, regardless of the amount and frequency of the pesticide application.

The mechanism by which the carbohydrate solution kills pests is not due to the toxicity of the solution with respect to the targeted pest, as is the case with conventional pesticides. Rather, the carbohydrate solution functions as a contact pesticide solution which kills the targeted pests through a plurality of other mechanisms.

When the carbohydrate pesticide solution is used on a crawling insect such as an ant, for example, it may be poured or sprayed directly onto the insect or it may be poured onto a region of soil in which the particular targeted insect dwells. The aqueous carbohydrate solution comes into contact with the insect. The carbohydrate solution on the insect contacts cilia located on an exterior portion of the insect. The carbohydrate solution may also contact the insect's antennae. The carbohydrate solution which contacts the cilia or antennae adheres to the cilia or antennae causing the insect to lose its orientation, since the cilia and antennae are two of the insect's main sensing organs. Additionally, on the insect's body are tiny holes, or spiracles, through which the insect obtains oxygen necessary for respiration. The carbohydrate solution also covers these tiny spiracles by adhering to an exterior portion of the insect, clogging and closing off the spiracles, and eventually weakening or suffocating the insect. Pests other than insects, for example arachnids, bear similar physical features to crawling insects, and consequently would be similarly affected by contact from the aqueous carbohydrate composition of the present invention.

When the carbohydrate pesticide solution is used on a flying insect such as a bee, wasp, or wood termite, for example, it is preferably sprayed directly onto the insect. Spraying allows for wider and more effective coverage of areas frequented by flying insects. When sprayed on a flying insect, the pesticide solution comes into contact with the insect and may disorient, weaken, or asphyxiate the insect by adhering to cilia, antennae, or spiracles located on the exterior of the insect. Additionally, in the case of flying insects, the solution contacts and adheres to the insect's wings. The solution adhered to the insect's wings interferes with and impairs the insect's ability to fly. The adhered carbohydrate solution is heavy relative to the insect's wings and the solid components of the solution do not evaporate but remain adhered to the insect. In many cases, the carbohydrate solution causes the insect's wings to adhere to each other. As a consequence the, flying insect loses its ability to fly and dies within a short period of time. The flying insect does not need to be encapsulated by the pesticide solution in order for the solution to be effective in killing the insect.

The composition of the present invention is composed of an aqueous solution wherein at least one carbohydrate compound is dissolved. The carbohydrate compounds used in the present invention are preferably polysaccharide compounds, and are more preferably starch compounds and modified starch compounds. The starch compounds used may be derived from a wide variety of starch materials, such as non-waxy cereal starches, waxy starches, and root starches. Typical starches which may be used include corn starch, wheat starch, potato starch, tapioca starch, grain sorghum starch, rice starch, or any other starches derived either naturally or synthetically. Non-waxy cereal starches are the preferred starches, with refined corn starch or modified refined corn starch products being particularly preferred.

The pesticide solution of the present invention is preferably composed of from approximately 3% to approximately 15% by weight of starch.

A pesticide solution which is to be used on colonies of ants in ant beds or mounds is preferably composed of from approximately 6% to approximately 12% by weight of starch. At concentrations below approximately 6% by weight of starch, the solution begins to lose effectiveness in killing the ants, and at concentrations above approximately 12% by weight of starch, the solution becomes too thick to flow throughout the ant beds or mounds. The solution is effective on ant beds or mounds located in various types of ground soil, including heavier dense soils, sandy coastal soils, and sandy volcanic type soils. A solution of approximately 9% to 12% by weight of starch is effective on most types of soil. However, a solution-which is approximately 6% by weight of starch is most effective on ant beds or mounds which are located in soil composed primarily of pure sand, such as is found in close proximity to a beach.

A solution used in combating ant colonies is applied to the ant bed in a quantity sufficient to permeate the ant bed. Applications of the pesticide solutions to ant beds in the appropriate quantity results in total ant kills of about 80% to about 90% following the first application. The remaining 10% to 20% of the ants show minimal activity. Usually within a day of application, a treated ant bed is vacated and a small new ant bed is established within 1 to 2 feet of the treated ant bed. A small dosage on the newly established ant bed results in 100% elimination of the ants.

A pesticide solution which is to be used on crawling insects in general is preferably composed of from approximately 7% to approximately 15% by weight of starch. At concentrations below approximately 7% by weight of starch, the solution begins to lose effectiveness in killing the crawling insects, and at concentrations above approximately 15% by weight of starch, the solution is reduced in effectiveness due to a prolonged drying time.

A pesticide solution which is to be used on flying insects is preferably composed of from approximately 4% to approximately 8% by weight of starch. At concentrations below approximately 4% by weight of starch, the solution begins to lose effectiveness in killing the flying insects, and at concentrations above approximately 8% by weight of starch, the solution becomes too thick to spray without using impractical mechanical means such as an airless spray gun.

The following examples illustrate the invention. It will be appreciated that the present invention is not limited to any of the exact constructions that are described below and that various modifications, changes, and variations can be made without departing from the scope and spirit thereof.

### EXAMPLE 1

A modified corn starch paste comprising approximately 30% by weight of solids is diluted with water to form a starch based solution. The modified corn starch paste is mixed with the water in volumetric concentrations of 10%, 25%, 33%, and 50%. Accordingly, the resulting mixed starch based solutions have concentrations of approximately 3%, 7.5%, 10%, and 15% by weight of starch components.

Each of the starch based solutions is applied to ant beds formed in heavier dense soil located in Baldwin County, Ala. A dosage of 0.5 gallons of each solution is poured onto ant beds having a mound less than 5 inches in diameter. A dosage of 1 gallon is used on beds having a mound from 5 to 12 inches in diameter. A dosage of 2 gallons is used on beds having a mound 12 to 18 inches in diameter.

The solution comprising 10% by volume of the modified corn starch paste results in no noticeable decrease in ant activity and the beds are still intact the day after application.

The solution comprising 25% by volume of the modified corn starch paste decreases ant activity and causes damage to the ant beds. The day after application, a portion of the ant beds are damaged and abandoned and the treated beds are being enlarged by surviving ants. Although there is a decrease in ant activity, the ant beds are still alive.

The solution comprising 33% by volume of the modified corn starch paste is the most effective of the solutions observed. The beds treated with this solution show an ant kill ratio of 80% a day after application. The remaining 20% of ants build a small new bed within 2 feet of the treated beds. Application of the same solution to the new beds results in a 100% kill ratio.

The solution comprising 50% by volume of the modified corn starch paste is too thick to run through the tunnels of the ant beds and accordingly remains primarily on the surface of the mounds. The day after application, the beds have a thick crust remaining on the surface of the mounds. There is no evidence of reduced activity or killing of the ants, with the exception of ants that happened to be on the surface of the mound during application of the solution. The beds themselves are regenerated by the ants at the periphery of the crusted ant mound.

### EXAMPLE 2

Starch based solutions of 25% and 33% by volume of modified corn starch paste are prepared in the same manner as in Example 1. Each solution is applied to ant beds located in Seminole County, Fla. The soil in which the ant beds are located is the type of sandy soil found in Florida and in the coastal plains of the East Coast and Gulf of the United States. A dosage of 0.5 gallons of each solution is poured onto ant beds having a mound less than 5 inches in diameter. A dosage of 1 gallon is used on beds having a mound from 5 to 12 inches in diameter. A dosage of 2 gallons is used on beds having a mound 12 to 18 inches in diameter.

The solution comprising 33% by volume of the modified corn starch paste is the most effective of the solutions observed. The beds treated with this solution show an ant kill ratio of 80% a day after application. The remaining 20% of ants build a small new bed within 2 feet of the treated bed. Application of the same solution to the new bed results in a 100% kill ratio.

### EXAMPLE 3

A starch based solution of 33% by volume of modified corn starch paste is prepared in the same manner as in Example 1. The solution is applied to ant beds formed at a first location in St. Croix, U.S. Virgin Islands. The soil at the first location is a rich volcanic type soil mixed with some sand. A dosage of 0.5 gallons of the solution is poured onto ant beds having a mound less than 5 inches in diameter. A dosage of 1 gallon is used on beds having a mound from 5 to 12 inches in diameter. A dosage of 2 gallons is used on beds having a mound 12 to 18 inches in diameter.

The solution comprising 33% by volume of the modified corn starch paste is the most effective of the solutions observed. The beds treated with this solution show an ant kill ratio of 80% a day after application. The remaining 20% of ants build a small new bed within 2 feet of the treated bed. Application of the same solution to the new bed results in a 100% kill ratio.

### EXAMPLE 4

A starch based solution of 33% by volume of modified corn starch paste is prepared in the same manner as in Example 1. A starch based solution of 20% by volume of modified corn starch paste is also prepared in the same manner as the solutions in Example 1. Each solution is applied to ant beds formed at a second location in St. Croix, U.S. Virgin Islands. The soil at the second location is located in close proximity to a beach and is composed primarily of pure sand. Each ant bed has a mound approximately 4 inches in diameter. A dosage of 0.5 gallons of the solution is poured onto the ant beds.

In this case, the solution comprising 33% by volume of the modified corn starch paste is too thick for the mounds, and results in the collapse of the small mound openings, preventing saturation of the tunnels and leaving the ants below the surface untouched.

The solution comprising 20% by volume of modified corn starch paste is more effective at flowing throughout the ant bed than the 33% solution. In contrast to mounds located in more dense soil types, the 20% solution takes several applications over a 24 to 36 hour period in order to completely kill the ants in the bed.

### EXAMPLE 5

A starch based solution of 20% by volume of modified corn starch paste is prepared in the same manner as the solutions in Example 1. The solution is dispensed using a pump type garden sprayer with an approximate air pressure of 35 to 45 PSI. The dispensed solution flows well and is consistently atomized.

The solution is sprayed on bees, wasps, and wet wood termites. The sprayed starch based solution forms a coating on the wings of each of the insects which impairs and eliminates their ability to fly. All of the sprayed insects which are flying at the time of spraying fall from the air immediately upon contact with the solution, and die within a short period of time.

A control solution composed only of water is sprayed onto the flying insects in the same manner shown above. The water is quickly evaporated or otherwise jettisoned from the insects' wings, and accordingly has no affect on the insects' ability to fly.

### EXAMPLE 6

A starch based solution of 33% by volume of modified corn starch paste is prepared in the same manner as in Example 1. The solution is applied to crawling insects using a pump type garden sprayer as shown in Example 5.

All of the crawling insects which are contacted with the solution die within a period of one hour.

1. A method of killing a pest using a nontoxic contact pesticide comprising the steps of:
contacting the pest with a carbohydrate-based aqueous solution which acts as the nontoxic contact pesticide,
wherein the carbohydrate-based aqueous solution is comprised of one or more carbohydrate compounds and water, and
wherein the solution adheres to the pest.

2. A method of killing a pest using a nontoxic contact pesticide according to claim 1, wherein the pest is killed through at least one mechanism of disorientation, weakening, asphyxiation, or impairment of ability to move due to contact with the carbohydrate-based aqueous solution.

3. A method of killing a pest using a nontoxic contact pesticide according to. claim 1, wherein the carbohydrate-based aqueous solution is sprayed on the pest.

4. A method of killing a pest using a nontoxic contact pesticide according to claim 1, wherein the pest is a flying insect.

5. A method of killing a pest using a nontoxic contact pesticide according to claim 4, wherein the carbohydrate-based aqueous solution is sprayed onto flying insect while it is airborne.

6. A method of killing a pest using a nontoxic contact pesticide according to claim 1, wherein the carbohydrate compound is present in the solution in an amount from approximately 3% to approximately 15% by weight.

7. A method of killing a pest using a nontoxic contact pesticide according to claim 4, wherein the carbohydrate compound is present in the solution in an amount from approximately 4% to approximately 8% by weight.

8. A method of killing a pest using a nontoxic contact pesticide according to claim 1, wherein at least one of the carbohydrate compounds is a starch compound.

9. A method of killing a pest using a nontoxic contact pesticide according to claim 8, wherein the starch compound is a refined corn starch or modified refined corn starch compound

10. A method of combating an ant colony using a nontoxic contact pesticide comprising the steps of:
applying a carbohydrate-based aqueous solution which acts as the nontoxic contact pesticide to a soil-based ant bed or mound in which the ant colony is located,
wherein the carbohydrate-based aqueous solution is comprised of one or more carbohydrate compounds and water.

11. A method of combating an ant colony according to claim 10, wherein the carbohydrate-based aqueous solution is applied in a quantity sufficient to permeate the soil-based ant bed or mound.

12. A method of combating an ant colony according to claim 10, wherein the carbohydrate compound is present in the solution in an amount from approximately 3% to approximately 15% by weight.

13. A method of combating an ant colony according to claim 10, wherein the carbohydrate compound is present in the solution in an amount from approximately 6% to approximately 12% by weight.

14. A method of combating an ant colony according to claim 10, wherein the carbohydrate compound is a starch compound.

15. A method of combating an ant colony according to claim 14, wherein the starch compound is a refined corn starch or modified refined corn starch compound.

16. A nontoxic contact pesticide composition comprising:
an aqueous solution for killing a pest or combating an insect colony, wherein a majority of the solution by weight is water, and a minority of the solution by weight is composed of one or more carbohydrate compounds.

17. A nontoxic contact pesticide according to claim 16, wherein one or more of the carbohydrate compounds is a starch compound.

18. A nontoxic contact pesticide according to claim 17, wherein the starch compound is a refined corn starch or modified refined corn starch compound.

19. A nontoxic contact pesticide according to claim 16, wherein the carbohydrate compounds are present in the solution in an amount from approximately 3% to approximately 15% by weight.
